(19) United States
(12) Patent Application Publication
(10) Pub. No.: US 2007/0100882 A1
(43) Pub. Date: May 3, 2007

(54) Content control of a user interface

(76) Inventors: Christian Hochwarth, Wiesloch (DE); Andreas S. Krebs, Karlsruhe (DE); Martin Erhard, Karlsruhe (DE); Marcus Philipp, Dielheim (DE)

Correspondence Address: FISH & RICHARDSON, P.C., PO BOX 1022, MINNEAPOLIS, MN, 55440-1022, US

(21) Appl. No.: 11/263,779

(22) Filed: Oct. 31, 2005

(51) Int. Cl. G06F 17/00

(52) U.S. Cl. 707/104.1

(57) ABSTRACT

The present disclosure provides, among other things, a method comprising loading learning content into a content player. The method further includes modifying a user interface of the content player in accordance with a command from the learning content. The user interface comprises a plurality of interface elements and at least a subset of the interface elements comprising navigational controls for controlling learning content. This modification of the user interface may include disabling one or more of the interface elements, automatically navigating between a first component and a second component of the content, and other processes or techniques.

### BACKGROUND

Today, an enterprise's survival in local or global markets at least partially depends on the knowledge and competencies of its employees, which may easily be considered a competitive factor for the enterprises (or other organizations). Shorter product life cycles and the speed with which the enterprise can react to changing market requirements are often important factors in competition and ones that underline the importance of being able to convey information on products and services to employees as swiftly as possible. Moreover, enterprise globalization and the resulting international competitive pressure are making rapid global knowledge transfer even more significant. Thus, enterprises are often faced with the challenge of lifelong learning to train a (perhaps globally) distributed workforce, update partners and suppliers about new products and developments, educate apprentices or new hires, or set up new markets. In other words, efficient and targeted learning is a challenge that learners, employees, and employers are equally faced with. But traditional classroom training typically ties up time and resources, takes employees away from their day-to-day tasks, and drives up expenses.

Electronic learning systems provide users with the ability to access course content directly from their computers, without the need for intermediaries such as teachers, tutors, and the like. Such systems have proven attractive for this reason (and perhaps others) and may include a master repository that stores existing versions of learning objects. These learning objects are typically developed in-house or received from third-party providers to achieve some particular learning objective. This course content can be presented in a display region of an interactive content player. The content player allows a user to navigate the content by selecting interactive navigation controls. The navigation controls can allow a user to move forward or backward through the content, or present a table of contents to the user. However, course content can itself present navigation controls in the display region for allowing the user to navigate the content. For example, this can arise where the content includes an audio/visual presentation that the user can view, pause, rewind, etc.

### SUMMARY

The present disclosure provides systems, methods, and software for controlling user interfaces via content. For example, one method comprises loading learning content into a content player. This method further includes modifying a user interface of the content player in accordance with a command from the learning content. The user interface comprises a plurality of interface elements and at least a subset of the interface elements comprising navigational controls for controlling learning content. This modification of the user interface may include disabling one or more of the interface elements, automatically navigating between a first component and a second component of the content, and other processes or techniques. The details of one or more embodiments are set forth in the accompanying drawings and the description below. Features, aspects, and advantages will be apparent from the description, drawings, and claims.

### DESCRIPTION OF DRAWINGS

FIG. 1 is a diagram illustrating an example learning environment according to one embodiment of the present disclosure;

FIG. 2 illustrates an example architecture of a learning management system implemented within the learning environment of FIG. 1;

FIG. 3 illustrates an example content aggregation model in the learning management system;

FIG. 4 is an example of one possible ontology of knowledge types used in the learning management system;

FIG. 5 illustrates an example run-time environment for the content player and the learning portal implemented within the learning environment of FIG. 1, as well as certain components of the example content player;

FIGS. 6A-D illustrate example user interfaces with one or more sets of navigation controls and modification of certain interface elements as determined by the particular content; and

FIG. 7 is a flow diagram of processing in accordance to various embodiments.

### DETAILED DESCRIPTION

FIG. 1 illustrates an example environment for a learning management system 140 that may deliver a blended learning solution of learning methods used in traditional classroom training, web-based training, and virtual classrooms. At a high level, such applications 140 provide convenient information on the learner 104's virtual workplace and at least partially control the learning process itself. The system proposes learning units based on the learner 104's personal data, tracks progress through courses and coordinates the personalized learning experience. In addition, learning management system 140 encompasses the administrative side of the learning platform, where a training administrator 105 structures and updates the offering and distributes it among the target groups. Moreover, the course offering is usually not restricted to internally hosted content. The learning management system 140 often offers robust reporting capabilities, including ad hoc reporting and business intelligence. These capabilities may provide in-depth analysis of the entire business or organization, thereby enabling better decision making. Learning management system 140 typically helps improve the quality of training and cut costs by reducing the travel and administrative costs associated with classroom training while delivering a consistent learning offering.

Such electronic learning systems present learning content in various different formats from multiple sources, both internal and external. This content may be presented to learner 104 using a content player comprising a media player, a browser implementing various scripts and programming, or other such interfaces. Such content players often include a content presentation screen, as well as a header and navigation bar. In these implementations, the header bar may show the title of the learning content and the navigation bar may be used to navigate between learning units, to open the table of contents screen, and to implement logging off. If the learning content controls the navigation flow inside a particular instructional element and the content player manages navigation between instructional elements, then this automatically leads to double navigation elements. Double navigation may be confusing for learners 104, since they do not know which navigation elements should be used and when. Accordingly, LMS 140 provides functionality, often through APIs, to allow the learning content to control the navigational controls, or other interface elements, thereby possibly reducing or eliminating double navigation and other potential interface issues. These APIs provide the particular developer of the content with the ability to create content with more specific internal controls without concern for external influences or redundancies. For example, an instructional element that contains some form of sub-navigation can turn off the navigation bar and trigger navigation to the next instructional element after the current one is completed. Alternatively, this example instructional element may turn navigation on again and let learner 104 decide where to navigate next. In another example, a designer of the instructional element, such as developer 106, may determine that it needs more screen space; in this case, he can allow or design the content to turn off the navigation and the header bar. In a further example, if the instructional element includes some form of test that should be passed before learners 104 are allowed to navigate forward, then the instructional element or other portion of the content may be designed to turn off (or otherwise disable) the navigation bar until the test is passed. In yet another example, if an instructional element determines that it should display a portion or all of the particular table of contents for some learning content, then it may read it in XML format and automatically render it accordingly. Of course, while content control of certain portions of the content player is described in terms of learning content and learning systems, such content control may be implemented in other media content and format, including music, video, and such.

Training administrators 105 may customize teaching scenarios by using web services to integrate external content, functions, and services into the learning platform from a remote or third party content provider 108. The training administrator 105 can administer internal and external participants (or learners 104) and enroll them for courses to be delivered via any number of techniques. Training management supports the respective organization, entity, or learner 104 in the day-to-day activities associated with course bookings. Booking activities can be performed by the training administrator in training management on an individual or group participant basis. For example, training administrator 105 can often request, execute, or otherwise manage the following activities in a dynamic participation menu presented in learning management system 140: i) prebook: if participants are interested in taking certain classroom courses or virtual classroom sessions, but there are no suitable dates scheduled, 30 learners 104 can be prebooked for the course types. Prebooking data can be used to support a demand planning process; ii) book: individual or group learners 104 (for example, companies, departments, roles, or other organizational units) can be enrolled for courses that can be delivered using many technologies; iii) rebook: learners 104 can book a course on an earlier or later date than originally booked; iv) replace: learners 104 can be swapped; and v) cancel: course bookings can be canceled, for example, if the learners 104 cannot attend.

Environment 100 is typically a distributed client/server system that spans one or more networks such as external network 112 or internal network 114. In such embodiments, data may be communicated or stored in an encrypted format such as, for example, using the RSA, WEP, or DES encryption algorithms. But environment 100 may be in a dedicated enterprise environment—across a local area network or subnet—or any other suitable environment without departing from the scope of this disclosure. Indeed, while generally described or referenced in terms of an enterprise, the components and techniques may be implemented in any suitable environment, organization, entity, and such. Turning to the illustrated embodiment, environment 100 includes or is communicably coupled with server 102, one or more learners 104 or other users on clients, and network 112. In this embodiment, environment 100 is also communicably coupled with external content provider 108.

Server 102 comprises an electronic computing device operable to receive, transmit, process and store data associated with environment 100. Generally, FIG. 1 provides merely one example of computers that may be used with the disclosure. Each computer is generally intended to encompass any suitable processing device. For example, although FIG. 1 illustrates one server 102 that may be used with the disclosure, environment 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UNIX, Windows Server, or any other suitable operating system. According to one embodiment, server 102 may also include or be communicably coupled with a web server and/or a mail server. Server 102 may also be communicably coupled with a remote repository over a portion of network 112. While not illustrated, the repository may be any intra-enterprise, inter-enterprise, regional, nationwide, or other electronic storage facility, data processing center, or archive that allows for one or a plurality of clients (as well as servers 102) to dynamically store data elements, which may include any business, enterprise, application or other transaction data. For example, the repository may be a central database communicably coupled with one or more servers 102 and clients via a virtual private network (VPN), SSH (Secure Shell) tunnel, or other secure network connection. This repository may be physically or logically located at any appropriate location including in one of the example enterprises or off-shore, so long as it remains operable to store information associated with environment 100 and communicate such data to at least a subset of plurality of the clients (perhaps via server 102).

As a possible supplement to or as a portion of this repository, server 102 normally includes some form of local memory. The memory may include any memory or database module and may take the form of volatile or non-volatile memory including, without limitation, magnetic media, optical media, random access memory (RAM), read-only memory (ROM), removable media, or any other suitable local or remote memory component. For example, the memory may store or reference a large volume of information relevant to the planning, management, and follow-up of courses or other content. This example data includes information on i) course details, such as catalog information, dates, prices, capacity, time schedules, assignment of course content, and completion times; ii) personnel resources, such as trainers who are qualified to hold courses; iii) room details, such as addresses, capacity, and equipment; and iv) participant data for internal and external participants. The memory may also include any other appropriate data such as VPN applications or services, firewall policies, a security or access log, print or other reporting files, HTML files or templates, data classes or object interfaces, child software applications or sub-systems, and others. In some embodiments, the memory may store information as one or more tables in a relational database described in terms of SQL statements or scripts. In another embodiment, the memory may store information as various data structures in text files, eXtensible Markup Language (XML) documents, Virtual Storage Access Method (VSAM) files, flat files, Btrieve files, comma-separated-value (CSV) files, internal variables, or one or more libraries. But any stored information may comprise one table or file or a plurality of tables or files stored on one computer or across a plurality of computers in any appropriate format. Indeed, some or all of the learning or content data may be local or remote without departing from the scope of this disclosure and store any type of appropriate data.

Server 102 also includes one or more processors. Each processor executes instructions and manipulates data to perform the operations of server 102 such as, for example, a central processing unit (CPU), a blade, an application specific integrated circuit (ASIC), or a field-programmable gate array (FPGA). Although this disclosure typically discusses computers in terms of a single processor, multiple processors may be used according to particular needs and reference to one processor is meant to include multiple processors where applicable. In the illustrated embodiment, the processor executes enterprise resource planning (ERP) solution 135, thereby providing organizations with the strategic insight, ability to differentiate, increased productivity, and flexibility they need to succeed. With software such as ERP solution 135, the implementing entity may automate end-to-end processes and extend those processes beyond the particular organization to the entire system by incorporating customers, partners, suppliers, or other entities. For example, ERP solution 135 may include or implement easy-to-use self-services and role-based access to information and services for certain users, thereby possibly boosting productivity and efficiency. In another example, ERP solution 135 may include or implement analytics that enable the particular entity or user to evaluate performance and analyze operations, workforce, and financials on an entity and individual level for strategic and operational insight. ERP solution 135 may further include or implement i) financials to control corporate finance functions while providing support for compliance to rigorous regulatory mandates; ii) operations to support end-to-end logistics for complete business cycles and capabilities that improve product quality, costs, and time to market; and/or iii) corporate services to optimize both centralized and decentralized services for managing real estate, project portfolios, business travel, environment, health and safety, and quality. In the illustrated embodiment, ERP solution 135 also includes or implements some form of human capital management (in this case, learning) to maximize the profitability or other measurable potential of the users, with support for talent management, workforce deployment, and workforce process management. In certain cases, ERP solution 135 may be a composite application that includes, execute, or otherwise implement some or all of the foregoing aspects, which include learning management system 140 as illustrated.

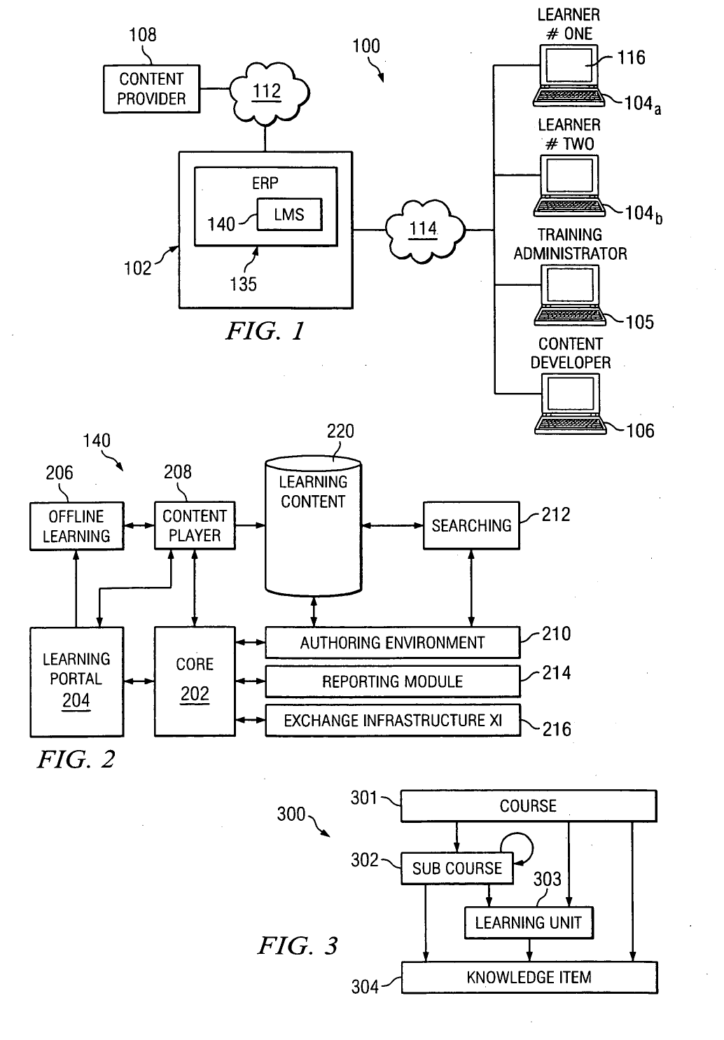

As briefly described above, learning management system 140 is any software operable to provide a comprehensive enterprise learning platform capable of managing and integrating business and learning processes and supporting all methods of learning, not restricted to e-learning or classroom training. As described in more detail in FIG. 2, learning management system 140 is often fully integrated with ERP solution 135 and includes an intuitive learning portal and a powerful training and learning management system, as well as content authoring, structuring, and management capabilities. Learning management system 140 offers back-office functionality for competency management and comprehensive assessment for performance management, and offers strong analytical capabilities, including support for ad hoc reporting. The solution uses a comprehensive learning approach to deliver knowledge to all stakeholders, and tailors learning paths to an individual's educational needs and personal learning style. Interactive learning units can be created with a training simulation tool that is also available.

Regardless of the particular implementation, “software” may include software, firmware, wired or programmed hardware, or any combination thereof as appropriate. Indeed, ERP solution 135 may be written or described in any appropriate computer language including C, C++, Java, J#, Visual Basic, assembler, Perl, any suitable version of 4GL, as well as others. For example, returning to the above described composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's NET. It will be understood that while ERP solution 135 is illustrated in FIG. 1 as including one sub-module learning management system 140, ERP solution 135 may include numerous other sub-modules or may instead be a single multi-tasked module that implements the various features and functionality through various objects, methods, or other processes. Further, while illustrated as internal to server 102, one or more processes associated with ERP solution 135 may be stored, referenced, or executed remotely. For example, a portion of ERP solution 135 may be a web service that is remotely called, while another portion of ERP solution 135 may be an interface object bundled for processing at the remote client. Moreover, ERP solution 135 and/or learning management system 140 may be a child or sub-module of another software module or enterprise application (not illustrated) without departing from the scope of this disclosure.

Server 102 may also include an interface for communicating with other computer systems, such as the clients, over networks, such as 112 or 114, in a client-server or other distributed environment. In certain embodiments, server 102 receives data from internal or external senders through the interface for storage in the memory and/or processing by the processor. Generally, the interface comprises logic encoded in software and/or hardware in a suitable combination and operable to communicate with networks 112 or 114. More specifically, the interface may comprise software supporting one or more communications protocols associated with communications network 112 or hardware operable to communicate physical signals.

Network 112 facilitates wireless or wireline communication between computer server 102 and any other local or remote computers, such as clients. Network 112, as well as network 114, facilitates wireless or wireline communication between computer server 102 and any other local or remote computer, such as local or remote clients or a remote content provider 108. While the following is a description of network 112, the description may also apply to network 114, where appropriate. For example, while illustrated as separate networks, network 112 and network 114 may be a continuous network logically divided into various sub-nets or virtual networks without departing from the scope of this disclosure. In some embodiments, network 112 includes access points that are responsible for brokering exchange of information between the clients. As discussed above, access points may comprise conventional access points, wireless security gateways, bridges, wireless switches, sensors, or any other suitable device operable to receive and/or transmit wireless signals. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. Turning to network 114, as illustrated, it may be all or a portion of an enterprise or secured network. In another example, network 114 may be a VPN between server 102 and a particular client across wireline or wireless links. In certain embodiments, network 114 may be a secure network associated with the enterprise and certain local or remote clients.

Each client is any computing device operable to connect or communicate with server 102 or other portions of the network using any communication link. At a high level, each client includes or executes at least GUI 116 and comprises an electronic computing device operable to receive, transmit, process and store any appropriate data associated with environment 100. It will be understood that there may be any number of clients communicably coupled to server 102. Further, “client” and “learner,” “administrator,” “developer” and “user” may be used interchangeably as appropriate without departing from the scope of this disclosure. Moreover, for ease of illustration, each client is described in terms of being used by one user. But this disclosure contemplates that many users may use one computer or that one user may use multiple computers. As used in this disclosure, the client is intended to encompass a personal computer, touch screen terminal, workstation, network computer, kiosk, wireless data port, smart phone, personal data assistant (PDA), one or more processors within these or other devices, or any other suitable processing device or computer. For example, the client may be a PDA operable to wirelessly connect with external or unsecured network. In another example, the client may comprise a laptop that includes an input device, such as a keypad, touch screen, mouse, or other device that can accept information, and an output device that conveys information associated with the operation of server 102 or other clients, including digital data, visual information, or GUI 116. Both the input device and output device may include fixed or removable storage media such as a magnetic computer disk, CD-ROM, or other suitable media to both receive input from and provide output to users of the clients through the display, namely the client portion of GUI or application interface 116.

GUI 116 comprises a graphical user interface operable to allow the user of the client to interface with at least a portion of environment 100 for any suitable purpose, such as viewing application or other transaction data. Generally, GUI 116 provides the particular user with an efficient and user-friendly presentation of data provided by or communicated within environment 100. As shown in later FIGUREs, GUI 116 may comprise a plurality of customizable frames or views having interactive fields, pull-down lists, and buttons operated by the user. GUI 116 may be a learning interface allowing the user or learner 104 to search a course catalog, book and cancel course participation, and support individual course planning (e.g., by determining qualification deficits and displaying a learner's completed, started, and planned training activities). Learner 104 also may access and work through web based courses using the learning interface. The learning interface may be used to start a course, reenter a course, exit a course, and take tests. The learning interface also provides messages, notes, and special course offerings to the learner 104. GUI 116 may also be a course editor allowing the content developer to create the structure for the course content, which may be associated with certain metadata. The metadata may be interpreted by a content player of learning management system 140 (described below) to present a course to learner 104 according to a learning strategy selected at run time. In particular, the course editor may enable the author or content developer 106 to classify and describe structural elements, assign attributes to structural elements, assign relations between structural elements, and build a subject-taxonomic course structure. The course editor generates the structure of the course and may include a menu bar, a button bar, a course overview, a dialog box, and work space. The menu bar may include various drop-down menus, such as, for example, file, edit, tools, options, and help. The drop-down menus may include functions, such as create a new course, open an existing course, edit a course, or save a course. The button bar may include a number of buttons. The buttons may be shortcuts to functions in the drop down menus that are used frequently and that activate tools and functions for use with the course editor. The remaining portions of the example course editor interface may be divided in to three primary sections or windows: a course overview, a dialog box, and a workspace. Each of the sections may be provided with horizontal or vertical scroll bars or other means allowing the windows to be sized to fit on different displays while providing access to elements that may not appear in the window.

GUI 116 may also present a plurality of portals or dashboards. For example, GUI 116 may display a portal that allows users to view, create, and manage historical and real-time reports including role-based reporting and such. Generally, historical reports provide critical information on what has happened including static or canned reports that require no input from the user and dynamic reports that quickly gather run-time information to generate the report. Of course, reports may be in any appropriate output format including PDF, HTML, and printable text. It should be understood that the term graphical user interface may be used in the singular or in the plural to describe one or more graphical user interfaces and each of the displays of a particular graphical user interface. Indeed, reference to GUI 116 may indicate a reference to the front-end or other component of learning management system 140, as well as the particular interface or learning portal accessible via the client, as appropriate, without departing from the scope of this disclosure. In short, GUI 116 contemplates any graphical user interface, such as a generic web browser or touch screen, that processes information in environment 100 and efficiently presents the results to the user. Server 102 can accept data from the client via the web browser (e.g., Microsoft Internet Explorer or Netscape Navigator) and return the appropriate HTML or XML responses to the browser using network 112 or 114, such as those illustrated in subsequent FIGUREs.

FIG. 2 illustrates one example implementation of learning management system (LMS) 140. In the illustrated embodiment, LMS 140 comprises four example components, namely i) a management system core 202, which controls learning processes and manages and handles the administrative side of training; ii) a learning portal 204, which is the learner's springboard into the learning environment, which allows him to access the course offering and information on personal learning data and learning activities; iii) an authoring environment 210, where learning content and tests are designed and structured; and iv) a content management system 220, where learning content is stored and managed. Generally, LMS 140 is aimed at learners 104, trainers 105, course authors 106 and instructional designers, administrators, and managers.

Learners 104 log on to their personalized learning portal 204 from any suitable client via GUI 116. The learning portal 204 is the user's personalized point of access to the learning-related functions. Generally, learning portal 204 presents details of the complete education and training offering, such as traditional classroom training, e-learning courses (such as virtual classroom sessions or web-based training), or extensive curricula. Self-service applications enable learners 104 to enroll themselves for courses, prebook for classroom courses, and cancel bookings for delivery methods, as well as start self-paced learning units directly. If learner 104 wants to continue learning offline, he can often download the courses onto the client and synchronize the learning progress later. The learning portal 204 may be seamlessly integrated in an enterprise portal, where learner 104 is provided with access to a wide range of functions via one system. Such an enterprise portal may be the learner's single point of entry and may integrate a large number of role-based functions, which are presented to the user in a clear, intuitive structure. The learning portal 204 often gives learner 104 access to functions such as, for example, search for courses using i) find functions: finding courses in the course catalog that have keywords in the course title or description; and ii) extended search functions: using the attributes appended to courses, such as target group, prerequisites, qualifications imparted, or delivery method. Additional functions may include self-service applications for booking courses and canceling bookings, messages and notes, course appraisals, and special (or personalized) course offering including courses prescribed for the learner 104 on the basis of his or her role in the enterprise or the wishes of the respective supervisor or trainer and qualification deficits of learner 104 that can be reduced or eliminated by participating in the relevant courses. The learning portal 204 may also provide a view of current and planned training activities, as well as access to courses booked, including: i) starting a course; ii) reentering an interrupted course; iii) downloading a course and continuing learning offline; iv) going online again with a downloaded course and synchronizing the learning progress; v) exiting a course; and vi) taking a test.

On the basis of the information the learning management system 140 has about learner 104, the learning management system core 202 proposes learning units for the learner 104, monitors the learner's progress, and coordinates the learner's personal learning process. In addition, the learning management system core 202 is often responsible for managing and handling the administrative processes. Targeted knowledge transfer may use precise matching of the learning objectives and qualifications of a learning unit with the learner's level of knowledge. For example, at the start of a course, the management system core 202 may compare learning objectives already attained by the respective learner 104 with the learning objectives of the course. On the basis of this, core 202 determines the learner's current level and the required content and scope of the course. The resulting course is then presented to the learner 104 via a content player 208.

The content player 208 is a virtual teacher that tailors learning content to the needs of the individual learner 104 and helps him navigate through the course; content player 208 then presents the learning course to the learner 104. In certain embodiments, the content player 208 is a Java application that is deployed on a Java runtime environment, such as J2EE. In this case, it is linked with other systems such as a web application server and ERP solution 135 via the Java Connector. The individual course navigation may be set up at runtime on the basis of the learning strategy stored in the learner account. Using the didactical strategies, content player 208 helps ensure that the course is dynamically adapted to the individual learning situation and the preferences expressed by learner 104. At this point, the content player 208 then calculates dynamically adjusted learning paths and presents these to the learner 104—perhaps graphically—to facilitate orientation within a complex subject area. When learner 104 starts a course, the learning objectives and qualifications achieved so far are compared with the qualifications imparted by the course. This may enable content player 208 to avoid offering redundant learning objects to learner 104 as part of the course. If a course has already been completed, a page is displayed with an appropriate message. On successful completion of a course, the learning objectives achieved are credited as qualifications to the learner's personal learner account. The learner 104 can resume working on an interrupted course at any time. At this point, the content player 208 guides the learner 104 to the spot at which training was interrupted.

Offline learning player 206 generally enables learners 104 to download network or other web-based courses from the learning portal 204 and play them locally. Locally stored courses are listed in the course list with an icon indicating the status of each course. The offline player 206 may guide the learner 104 through the course according to the preferred learning strategy. It may also dynamically adjust the number and sequence of learning objects to the learner's individual learning pattern. If the learner 104 interrupts a course, the offline player 206 reenters the course at the point of interruption the next time. The learner 104 can, at any point in time, resynchronize his offline learning progress with the learning portal 204 and either continue learning online or set the course to a completed status.

LMS core 202 may also include or invoke training management that would be an administrative side of LMS 140. This typically includes course planning and execution, booking and cancellation of course participation, and follow-up processing, including cost settlement. In training management, the training administrator 105 creates the course offering and can, for example, define training measures for individual learners 104 and groups of learners 104. The training administrator 105 creates the course catalog in training management and makes it available (partially or completely) to learners 104 in the learning portal 204 for reference and enrollment purposes. The training administrator 105 can typically administer internal and external participants and enroll them for courses to be delivered using various technologies and techniques. Training management supports numerous business processes involved in the organization, management, and handling of training. Training management can be configured to meet the requirements, work processes, and delivery methods common in the enterprise. Training measures are usually flexibly structured and may include briefings, seminars, workshops, virtual classroom sessions, web-based trainings, external web-based trainings, static web courses, or curricula. Training management includes functions to efficiently create the course offerings. Using course groups to categorize topics by subject area enables flexible structuring of the course catalog. For example, when training administrator 105 creates a new subject area represented by a course group, he can decide whether it should be accessible to learners 104 in the learning portal 202.

Reporting functions 214 in training management enable managers to keep track of learners' learning activities and the associated costs at all times. Supervisors or managers can monitor and steer the learning processes of their employees. They can be notified when their employees request participation or cancellation in courses and can approve or reject these requests. LMS 140 may provide the training manager with extensive support for the planning, organization, and controlling of corporate education and training. Trainers need to have up-to-the-minute, reliable information about their course schedules. There is a wide range of reporting options available in training management to enable the trainer to keep track of participants, rooms, course locations, and so on.

Authoring environment 210 contains tools and wizards that content developers 106 and instructional designers can use to create or import external course content. External authoring tools can be launched directly via authoring environment 210 to create learning content that can be integrated into learning objects and combined to create complete courses (learning nets). Attributes may be appended to content, thereby allowing learners 104 to structure learning content more flexibly depending on the learning strategy they prefer. Customizable and flexible views allow subject matter experts and instructional designers to configure. and personalize the authoring environment 210. To create the HTML pages for the content, the user can easily and seamlessly integrate editors from external providers or other content providers 108 into LMS 140 and launch the editors directly from authoring environment 210. Authoring environment 210 often includes a number of tools for creating, structuring, and publishing course content and tests to facilitate and optimize the work of instructional designers, subject matter experts, and training administrators 105. Authoring environment 210 may contain any number of components or sub-modules such as an instructional design editor is used by instructional designers and subject matter experts to create and structure learning content (learning nets and learning objects), a test author is used by instructional designers and subject matter experts to create web-based tests, and a repository explorer is for training administrators and instructional designers to manage content.

In the illustrated embodiment, course content is stored and managed in content management system 220. Put another way, LMS 140 typically uses the content management system 220 as its content storage location. But a WebDAV (Web-based Distributed Authoring and Versioning) interface (or other HTTP extension) allows integration of other WebDAV-enabled storage facilities as well without departing from the scope of this disclosure. Content authors or developers 106 publish content in the back-end training management system. Links to this content assist the training administrator 105 in retrieving suitable course content when planning web-based courses. A training management component of LMS 140 may help the training administrator 105 plan and create the course offering; manage participation, resources, and courses; and perform reporting. When planning e-learning courses, the training administrator 105 uses references inserted in published courses to retrieve the appropriate content in the content management system for the courses being planned. Content management system 220 may also include or implement content conversion, import, and export functions, allowing easy integration of Sharable Content Object Reference Model (SCORM)-compliant courses from external providers or other content providers 108. Customers can create and save their own templates for the various learning elements (learning objects, tests, and so on) that define structural and content-related specifications. These provide authors with valuable methodological and didactical support.

LMS 140 and its implemented methodology typically structure content so that the content is reusable and flexible. For example, the content structure allows the creator of a course to reuse existing content to create new or additional courses. In addition, the content structure provides flexible content delivery that may be adapted to the learning styles of different learners. E-learning content may be aggregated using a number of structural elements arranged at different aggregation levels. Each higher level structural element may refer to any instances of all structural elements of a lower level. At its lowest level, a structural element refers to content and may not be further divided. According to one implementation shown in FIG. 3, course material 300 may be divided into four structural elements: a course 301, a sub-course 302, a learning unit 303, and a knowledge item 304.

Starting from the lowest level, knowledge items 304 are the basis for the other structural elements and are the building blocks of the course content structure. Each knowledge item 304 may include content that illustrates, explains, practices, or tests an aspect of a thematic area or topic. Knowledge items 304 typically are small in size (i.e., of short duration, e.g., approximately five minutes or less). Any number of attributes may be used to describe a particular knowledge item 304 such as, for example, a name, a type of media, and a type of knowledge. The name may be used by a learning system to identify and locate the content associated with a knowledge item 304. The type of media describes the form of the content that is associated with the knowledge item 304. For example, media types include a presentation type, a communication type, and an interactive type. A presentation media type may include a text, a table, an illustration, a graphic, an image, an animation, an audio clip, and a video clip. A communication media type may include a chat session, a group (e.g., a newsgroup, a team, a class, and a group of peers), an email, a short message service (SMS), and an instant message. An interactive media type may include a computer based training, a simulation, and a test.

Knowledge item 304 also may be described by the attribute of knowledge type. For example, knowledge types include knowledge of orientation, knowledge of action, knowledge of explanation, and knowledge of source/reference. Knowledge types may differ in learning goal and content. For example, knowledge of orientation offers a point of reference to the learner, and, therefore, provides general information for a better understanding of the structure of interrelated structural elements. Each of the knowledge types are described in further detail below.

Knowledge items 304 may be generated using a wide range of technologies, often allowing a browser (including plug-in applications) to be able to interpret and display the appropriate file formats associated with each knowledge item. For example, markup languages (such as HTML, a standard generalized markup language (SGML), a dynamic HTML (DHTML), or XML), JavaScript (a client-side scripting language), and/or Flash may be used to create knowledge items 304. HTML may be used to describe the logical elements and presentation of a document, such as, for example, text, headings, paragraphs, lists, tables, or image references. Flash may be used as a file format for Flash movies and as a plug-in for playing Flash files in a browser. For example, Flash movies using vector and bitmap graphics, animations, transparencies, transitions, MP3 audio files, input forms, and interactions may be used. In addition, Flash allows a pixel-precise positioning of graphical elements to generate impressive and interactive applications for presentation of course material to a learner.

Learning units 303 may be assembled using one or more knowledge items 304 to represent, for example, a distinct, thematically-coherent unit. Consequently, learning units 303 may be considered containers for knowledge items 304 of the same topic. Learning units 303 also may be considered relatively small in size (i.e., duration) though larger than a knowledge item 304.

Sub-courses 302 may be assembled using other sub-courses 302, learning units 303, and/or knowledge items 304. The sub-course 302 may be used to split up an extensive course into several smaller subordinate courses. Sub-courses 302 may be used to build an arbitrarily deep nested structure by referring to other sub-courses 302.

Courses may be assembled from all of the subordinate structural elements including sub-courses 302, learning units 303, and knowledge items 304. To foster maximum reuse, all structural elements should be self-contained and context free.

Structural elements also may be tagged with metadata that is used to support adaptive delivery, reusability, and search/retrieval of content associated with the structural elements. For example, learning object metadata (LOM), per maps defined by the IEEE “Learning Object Metadata Working Group,” may be attached to individual course structure elements. The metadata may be used to indicate learner competencies associated with the structural elements. Other metadata may include a number of knowledge types (e.g., orientation, action, explanation, and resources) that may be used to categorize structural elements.

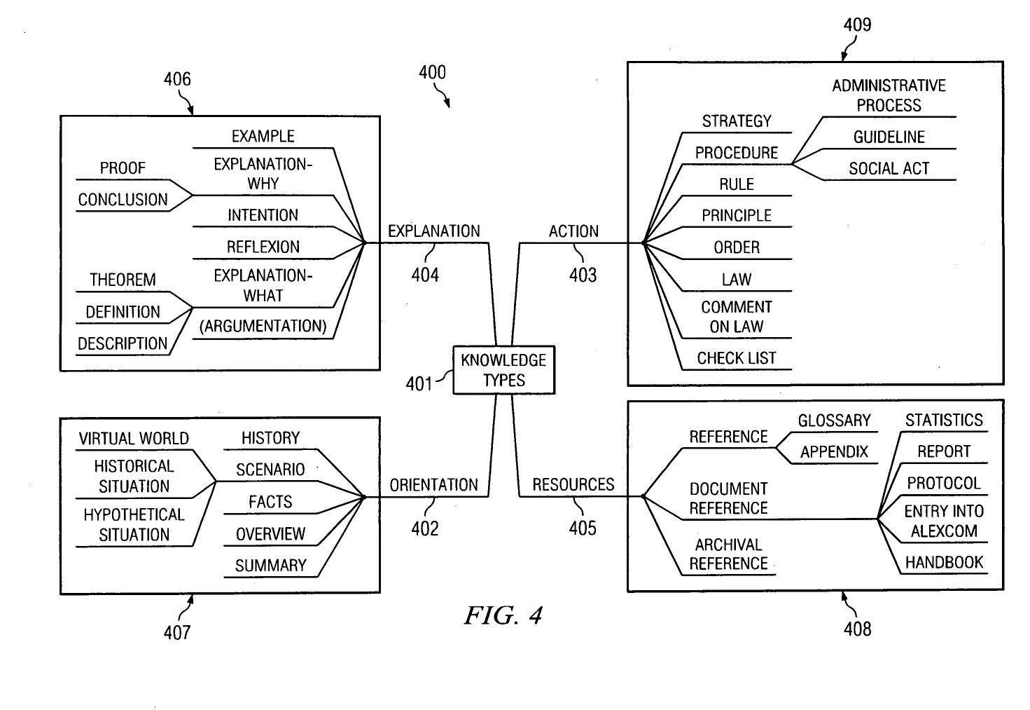

As shown in FIG. 4, structural elements may be categorized using a didactical ontology 400 of knowledge types 401 that includes orientation knowledge 402, action knowledge 403, explanation knowledge 404, and resource knowledge 405. Orientation knowledge 402 helps a learner 104 to find their way through a topic without being able to act in a topic-specific manner and may be referred to as “know what.” Action knowledge 403 helps a learner to acquire topic related skills and may be referred to as “know how.” Explanation knowledge 404 provides a learner with an explanation of why something is the way it is and may be referred to as “know why.” Resource knowledge 405 teaches a learner where to find additional information on a specific topic and may be referred to as “know where.”

The four knowledge types (orientation, action, explanation, and reference) may be further divided into a fine grained ontology. For example, orientation knowledge 402 may refer to sub-types 407 that include a history, a scenario, a fact, an overview, and a summary. Action knowledge 403 may refer to sub-types 409 that include a strategy, a procedure, a rule, a principle, an order, a law, a comment on law, and a checklist. Explanation knowledge 404 may refer to sub-types 406 that include an example, an intention, a reflection, an explanation of why or what, and an argumentation. Resource knowledge 405 may refer to sub-types 408 that include a reference, a document reference, and an archival reference.

Dependencies between structural elements may be described by relations when assembling the structural elements at one aggregation level. A relation may be used to describe the natural, subject-taxonomic relation between the structural elements. A relation may be directional or non-directional. A directional relation may be used to indicate that the relation between structural elements is true only in one direction. Directional relations should be followed. Relations may be divided into two categories: subject-taxonomic and non-subject taxonomic.

Subject-taxonomic relations may be further divided into hierarchical relations and associative relations. Hierarchical relations may be used to express a relation between structural elements that have a relation of subordination or superordination. For example, a hierarchical relation between the knowledge items A and B exists if B is part of A. Hierarchical relations may be divided into two categories: the part/whole relation (i.e., “has part”) and the abstraction relation (i.e., “generalizes”). For example, the part/whole relation “A has part B” describes that B is part of A. The abstraction relation “A generalizes B” implies that B is a specific type of A (e.g., an aircraft generalizes a jet or a jet is a specific type of aircraft).

Associative relations may be used refer to a kind of relation of relevancy between two structural elements. Associative relations may help a learner obtain a better understanding of facts associated with the structural elements. Associative relations describe a manifold relation between two structural elements and are mainly directional (i.e., the relation between structural elements is true only in one direction). Examples of associative relations include “determines,” “side-by-side,” “alternative to,” “opposite to,” “precedes,” “context of,” “process of,” “values,” “means of,” and “affinity.”

The “determines” relation describes a deterministic correlation between A and B (e.g., B causally depends on A). The “side-by-side” relation may be viewed from a spatial, conceptual, theoretical, or ontological perspective (e.g., A side-by-side with B is valid if both knowledge objects are part of a superordinate whole). The side-by-side relation may be subdivided into relations, such as “similar to,” “alternative to,” and “analogous to.” The “opposite to” relation implies that two structural elements are opposite in reference to at least one quality. The “precedes” relation describes a temporal relationship of succession (e.g., A occurs in time before B (and not that A is a prerequisite of B). The “context of” relation describes the factual and situational relationship on a basis of which one of the related structural elements may be derived. An “affinity” between structural elements suggests that there is a close functional correlation between the structural elements (e.g., there is an affinity between books and the act of reading because reading is the main function of books).

Non Subject-Taxonomic relations may include the relations “prerequisite of” and “belongs to.” The “prerequisite of” and the “belongs to” relations do not refer to the subject-taxonomic interrelations of the knowledge to be imparted. Instead, these relations refer to the progression of the course in the learning environment (e.g., as the learner traverses the course). The “prerequisite of” relation is directional whereas the “belongs to” relation is non-directional. Both relations may be used for knowledge items 304 that cannot be further subdivided. For example, if the size of the screen is too small to display the entire content on one page, the page displaying the content may be split into two pages that are connected by the relation “prerequisite of.”

Another type of metadata is competencies. Competencies may be assigned to structural elements, such as, for example, a sub-course 302 or a learning unit 303. The competencies may be used to indicate and evaluate the performance of a learner as learner 104 traverses the course material. A competency may be classified as a cognitive skill, an emotional skill, a senso-motorical skill, or a social skill.

As described in more detail below, learner 104 may choose between one or more learning strategies to determine which path to take through course 301. As a result, the progression of learners 104 through the course 301 may differ. Learning strategies may be created using macro-strategies and micro-strategies. Learner 104 may select from a number of different learning strategies when taking course 301. These learning strategies may be selected at run time of the presentation of course content to learner 104. As result, course authors 106 may be relieved from the burden of determining a sequence or an order of presentation of the course material. Instead, developers 106 may focus on structuring and annotating the course material. In addition, authors 106 may not be required to apply complex rules or Boolean expressions to domain models, thus minimizing or reducing the training necessary to use the system. Further, the course material may be easily adapted and reused to edit and create new courses.

Macro-strategies are used in learning strategies to refer to the coarse-grained structure of a course (i.e., the organization of sub-courses 302 and learning units 303). The macro-strategy determines the sequence that sub-courses 302 and learning units 303 of a course 301 are presented to the learner. For example, content player 208 uses the macro strategy to determine the sequence in which learning objects are displayed in the browser. For example, the following macro strategies may be used in content player 208: i) Table of contents; ii) deductive; iii) inductive; and iv) SCORM. The table of contents strategy uses the table of contents of the learning net, ignoring relationships. This means that the learning objects are displayed in the sequence in which they are arranged in the learning net. The deductive strategy generally arrange the objects from general to specific using the hierarchical relationships between learning objects; i.e., learner 104 can work through the hierarchy from the top down. The inductive strategy goes from specific to general by allowing learner 104 to work through the hierarchy from the top down. However, there is often only a brief orientation given for each learning object, as you go down through the hierarchy. This is true for all elements down to the lowest. Then, learner 104 works his way up through the hierarchy again with the desired level of detail. The SCORM strategy for learning nets out of external learning management systems that are imported as SCORM courses (the data format used for the exchange). Of course, these are merely example macro-strategies and any appropriate learning strategies may be used including none, some, or all of the foregoing examples.

Micro-strategies, implemented by the learning strategies, target the learning progression within a learning unit. The micro-strategies determine the order that knowledge items of a learning unit are presented. Micro-strategies refer to the attributes describing the knowledge items. Examples of micro-strategies include “orientation only”, “action oriented”, “explanation oriented”, “orientation oriented”, “table of contents”, “initial orientation”, “task oriented”, “example oriented”, and SCORM.

The micro-strategy “orientation only” ignores all knowledge items that are not classified as orientation knowledge. The “orientation only” strategy may be best suited to implement an overview of the course. The micro-strategy “action oriented” first picks knowledge items that are classified as action knowledge. All other knowledge items are sorted in their natural order (i.e., as they appear in the knowledge structure of the learning unit). The micro-strategy “explanation oriented” is similar to action oriented and focuses on explanation knowledge. For example, “explanation oriented” may displays explanatory knowledge to start with and then other knowledge types. The micro-strategy “orientation oriented” is similar to action oriented and focuses on orientation knowledge. The micro-strategy “table of contents” operates like the macro-strategy table of contents (but on a learning unit level). The micro-strategy “initial orientation” displays orientation knowledge to start with and then other knowledge types. The micro-strategy “task-oriented” displays practical instruction/action to start with and then other knowledge types. The micro-strategy “example oriented” displays example knowledge to start with and then other knowledge types. The micro-strategy SCORM is the strategy used with the corresponding SCORM macro strategy.

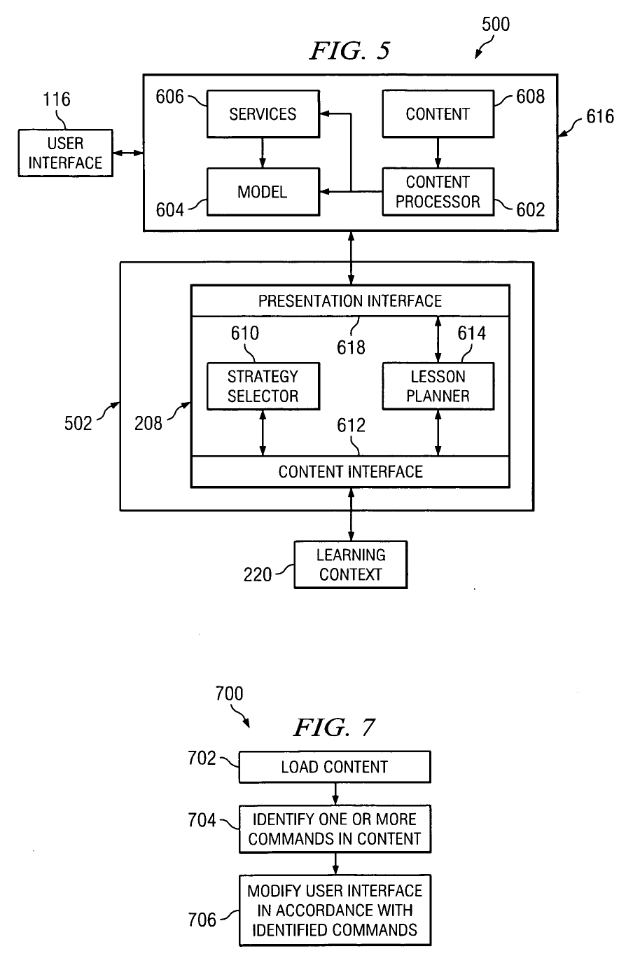

FIG. 5 illustrates a system 500 for presenting course content, perhaps using the foregoing strategies. Although the illustrated components are logically organized into groups for discussion purposes, components may be, for example, distributed on one or more computing devices connected by one or more networks, shared memory, inter-processor communication channels, or other suitable means. There may be more or fewer components without departing from the scope and spirit of this disclosure. An individual component's functionality can be distributed on one or more computing devices. For example, FIG. 2 illustrates LMS 140 including, among other things, content player 208 and learning portal 204. This example learning portal 204 allows learner 104 to start a new course or continue a previously initiated course using content player 208. Both the learning portal 204 and the content player 208 can access learning content 220 (provide by content 106 or content provider 108) through objects or services in a runtime environment 502. Learning content can be persisted in any number of ways including, for example, with one or more files, databases, repositories, virtual repositories, and content management systems. Content player 208 can include, present, or otherwise utilize user interface 116 to present representations of content including, for example, HTML, SGML, DHTML, XML, JavaScript, or Flash.

By way of illustration, runtime environment 502 can provide the ability to create one or more processes, threads or other units of execution with access to local and remote resources/services (e.g., virtual memory, threads, processes, web services, user interface 116, learning content 220, and content provider 108), intra-process and inter-process communication facilities, authorization and authentication services, and/or exception handling. Runtime environment 502 can be distributed across one or more computing devices. In one implementation, the runtime environment 502 is the Java 2 Platform, Enterprise Edition (J2EE).

In a more detailed embodiment, the user interface 116 is communicably coupled to a presentation component 616 which is part of content player 208. Content player 208 includes, references, or otherwise presents a number of interface elements available for displaying or managing a course. For example, the topic of the course or learning object is displayed in the header in the upper part of the screen. The content of the learning object may be displayed in the center screen area. The navigation bar is located in the lower screen area and allows learner 104 to activate all of the navigation functions for a course. For example, content player 208 may present the following navigation controls or interface elements: back, next, table of contents, path, and others. In this example, the back interface element allows learner 104 to go back to the previous learning object. Navigation steps from other sessions are also often taken into account at this point. The next interface element allows learner 104 to move on to the next object. This navigation may happen in a time axis according to the selected learning strategy. In short, if learner 104 navigates using “back,” then content player 208 goes back in this history. If learner 104 then navigates again with “next,” then content player 208 returns to the learning content that was most recently edited. The “table of contents” element displays an overview of the content of a course. In the dialog box, the learning objects are presented in the sequence in which the author created them. This view is often independent of the learning strategy selected. In the table of contents, entries that learner 104 can access are usually highlighted in some fashion. Access to entries depends on the learner's completion status and the learning strategy selected. The path interface element may allow learner 104 to know where he is in this course. A dialog box may appear with an overview of the course. The overview may depend on the learning strategy selected. If the course was started from learning portal 204, then the learning strategy selected in the portal is displayed in the dialog box. If the course was started from authoring environment 210, then the selected macro strategy (perhaps with its corresponding micro strategy) may be displayed in the dialog box. In the upper part of the dialog box, the system displays the instructional elements or other content in the current learning object. In the lower part of the screen, learning objects and learning nets that are in the environment of the current path are displayed on a dark background. As above, elements that learner 104 has already displayed or completed and the learning object currently in process may be flagged accordingly. Other example interface elements include settings, print, help, and log off. The settings element allows learner 104 to switch learning strategies or reset progress already attained in a course. The print element prints out the content of a course. In certain case, the print element only prints the page that is currently displayed. The navigation and the path may not be printed as appropriate. The help interface element presents a dialog box that displays learner-specific help for, inter alia, navigating in the content player 208. The example log off element allows learner 104 to log off in a controlled fashion. In this case, the achieved learning objectives are entered in the learner account and the system saves the point at which the course was interrupted to help ensure that the learner can resume at the same point. After logging off, the dialog box is usually closed if the course was started from the portal and has been fully completed.

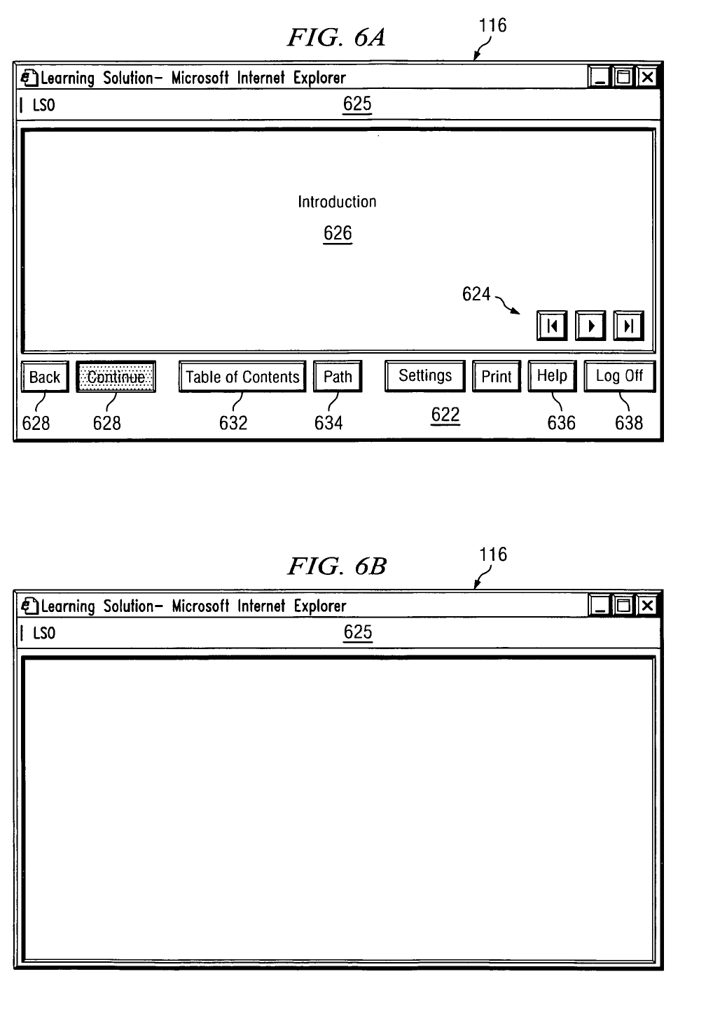

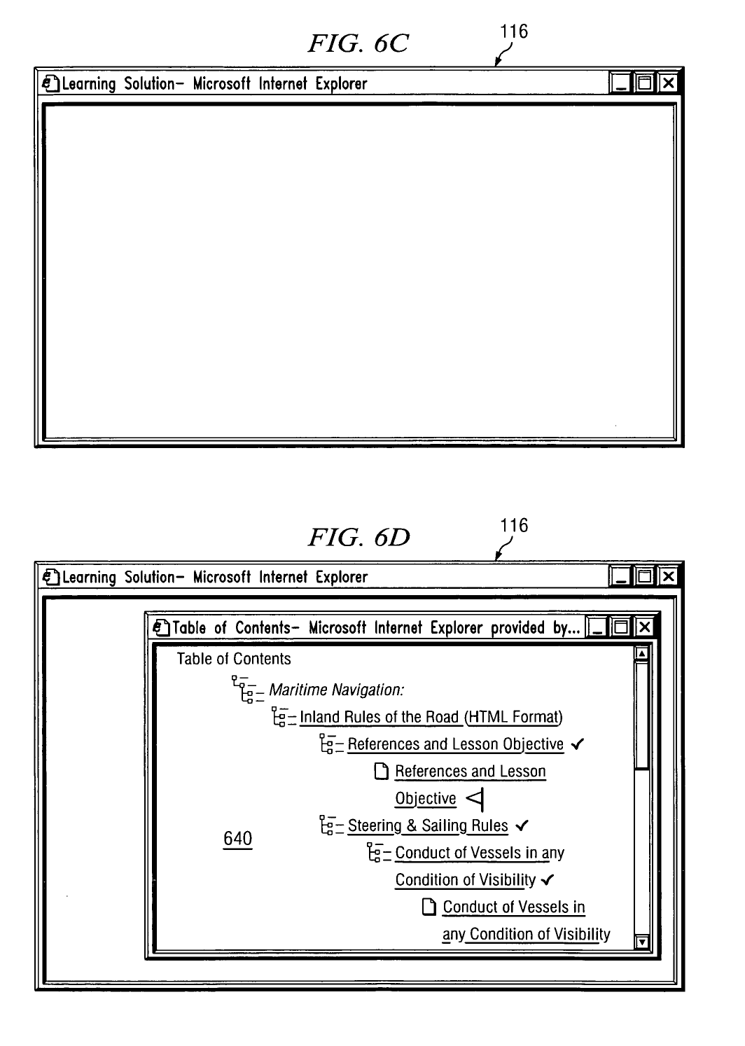

Returning to the illustrated embodiment, presentation component 616 interacts with the user interface 116 to manifest course content in a presentation 626 (such as that illustrated in FIGS. 6A-D) and to receive user input. The presentation component 616 receives the content 608 from content player 208, a web service, cache file, or other suitable source. The content 608 can include discrete or streaming portions and may include one or more content representations. In one embodiment, the presentation component 616 is a web browser or other suitable application, or a proxy for such.

In presenting content 608, the presentation component 616 can also present one or more user interface elements 622 in a footer area. The presentation component can also present a header area 625 for displaying messages or status. In certain cases, content 608 may include its own interface elements 624 that are in addition to or redundant to those present by content player 208. See FIG. 6A. The user interface elements 622 (or “navigation controls”) allow a user to navigate the course content 608, for example. Course navigation can be set up at runtime on the basis of a learning strategy (e.g. stored in the learner account). The navigation controls 622 are separate from, and may be in addition to, any such elements that are presented as part of the content presentation 626. For example, if the content representation 608 includes a Flash presentation, the presentation 626 can include its own user interface elements 624 for controlling the presentation, apart from the navigation controls 622. Back button 628 user interface element allows the user to move backwards through the course. A continue button 630 alternately allows the user to pause and resume the course. Selecting a table of contents button 632 presents a table of contents for the course which can allow the user to directly navigate to a section of interest. A path button 634 allows the user to view their current path through a course. A settings button, a print button, a help button 636, a path button 634, and a log off button 638 enable the user to change settings for the content player, print some or all of the course content, invoke a help system and log off from the content player, respectively. The forgoing descriptions of user interface elements 622 are merely examples of possible implementations. Many other types of user interface elements and configurations are possible within the scope of the present disclosure.

Referring again to FIG. 5, presentation component 616 includes a content processor 602 which can process content 608. Content processor 602 can perform any processing of the content 608 to create or update the content presentation 626. In one embodiment, content processor 602 parses one or more portions of content 608 where the content can include, without limitation, HTML, SGML, DHTML, XML, JavaScript or Flash or suitable formats. In one embodiment, content processor 602 can be implemented as a web browser plug-in or an applet. Content processor 602 can modify a model 604 of the user interface 116 in order to affect the user interface 116. The model 604 can be a hierarchical representation of the components comprising the rendered user interface 116. Changes to the model 604 can be automatically reflected in the rendered user interface 116. In one implementation, the model 604 is a Document Object Model (DOM).

Content 608 can contain commands, metadata or other information that can be used to trigger modification of user interface 116, including modification (such as disabling, triggering, moving, resizing, and others) of navigation controls 622, header 625 and other interface elements. By way of a non-limiting illustration, a command can be one or more statements in a programming language, metadata, an identifier, or other information that is part of the content 626. In one embodiment, the commands are JavaScript statements that cause the invocation of JavaScript functions. Table 1 is an exemplary listing of JavaScript functions that are included in services 606 and can be invoked from the content processor 602. In one implementation, these functions cause modification of the model 604.

TABLE 1

| FUNCTION NAME | DESCRIPTION |
|---|---|
| HideFooter | Hides the navigation controls 622 in user inter- |
| | face 116 and thus puts the content in charge of |
| | navigating the course. |
| ShowFooter | Shows the navigation controls 622 in user inter- |
| | face 116. |
| HideHeader | Hides the header bar 625 in user interface 116. |
| ShowHeader | Shows the header bar 625 in user interface 116. |
| NavigateForward | Triggers content navigation to present the next |
| | instructional component or portion of a course |
| | in user interface 116. |
| NavigateBackward | Triggers content navigation to present the pre- |
| | vious component or portion of a course in user |
| | interface 116. |
| Logout | Triggers a log off from the content player 208. |
| OpenTOC | Triggers presentation of a table of contents 640 |
| | in user interface 116. |
| CloseTOC | Triggers closing of a table of contents 640 in |
| | user interface 116. |
| OpenSettings | Opens a settings window in user interface 116. |
| CloseSettings | Closes a settings window in user interface 116. |
| OpenPath | Opens a path window in user interface 116. |
| ClosePath | Closes a path window in user interface 116. |
| GetVersion | Acquires the current version of the system. |
| Get_XML_TOC_URL | Provides the URL that can be invoked to obtain |
| | the table of contents 640 in XML format. |
| NavigateToNode | Navigates to a specific course node or instruc- |
| | tional element. |

In one embodiment, these commands may be provided through services 606. The services can include functionality for creating, destroying, altering, enabling, disabling, hiding or showing navigation controls 622. The services 608 can include an application programming interface (API) or other suitable programmatic means for altering the model. This API may offer developer 106 the option of steering or modifying the user interface of content player from the content by providing a number of functions that can be executed dynamically at runtime from the content. For example, developer 106 might decide to hide the navigation bar (as illustrated in FIG. 6B) or the header completely (as illustrated in FIG. 6C). In another example, learners 104 often steer their progress through a course or its table of contents triggered by the content (as illustrated in FIG. 6D). Equally, developer 106 can steer from the content, thus automatically guiding learner 104 through the course without some or all of the ability to influence the sequence. These services 606 can be invoked by the content processor 602 before, during or after processing the content 608 and in accordance to commands encountered in the content 608.

By way of a non-limiting illustration, the services can be used to hide navigation controls 622 when user interface elements 624 are present, or perform navigation of the content without requiring presentation of the navigation controls 622. Doing so may prevent users from becoming confused by the presentation of two sets of controls (622, 624). FIGS. 6B-D illustrate the user interface 116 after various content commands have been executed to disable, hide or remove certain interface elements. Also illustrated in the user interface 116 is a table of contents 640 created as a result of the command(s), which could have alternatively been presented if the user had selected button 632. By way of further illustration, commands in the content 608 can automatically trigger navigation of course content without requiring the navigation controls 622 to be presented. For example, when a user completes a course, command(s) in the content can trigger navigation of the 116.

The presentation component 616 is communicably coupled to content player 208 or a proxy for such. A content interface 612 in the content player 208 allows the content player 208 to access learning content 220, content provider 108, or other sources of content. The content interface 612 presents a uniform interface to the content player 208 regardless of the particulars of the learning content 220. The content interface 612 can include, by way of illustration, an API or other suitable means that implements or uses a communication protocol between the content player 502 and the learning content 220.

A strategy selector component 610 of the content player 208 can be used to select a learning strategy. As described above, content metadata may be interpreted to present a course to learner 104 according to a learning strategy selected at run time. Metadata can classify and describe structural course content elements, assign attributes to structural elements, assign relations between structural elements, and build a subject-taxonomic course structure. A lesson planner component 614 can tailor content retrieved through the content interface 612 to the needs of an individual learner 104 and establish course navigation according to the learning strategy. The lesson planner provides course content and navigation info 608 to the presentation component 616. In one embodiment, the course content can contain one or more commands to modify the user interface elements 622.

FIG. 7 is a flow diagram 700 of processing in accordance to various embodiments. Content 626 is loaded into a content player 208 (step 702). The content includes one or more representations of a course of study, and one or more commands for modifying the user interface 116. A content player process 602 identifies the one or more commands in the content (step 704). User interface 116, such as that presented by content player 208, is modified in accordance with the commands (step 706). In one embodiment, the commands are used to invoke services 606 for modifying a model 604 of the user interface 116.

A number of embodiments have been described. Nevertheless, it will be understood that various modifications may be made without departing from the spirit and scope of the disclosure. For example, as described earlier, such content control techniques may be implemented in various systems, such as enterprises or home user computers, presenting or developing any suitable content. Indeed, such content may not be related to “learning,” but may instead involve entertainment and sports, presentations, marketing, or any other suitable media or environment. Accordingly, other embodiments are within the scope of the following claims.

What is claimed is:

1. A computer-implemented method, comprising:
loading learning content into a content player; and
modifying a user interface of the content player in accordance with a command from the learning content, the user interface comprising a plurality of interface elements and at least a subset of the interface elements comprising navigational controls for controlling learning content.

2. The method of claim 1, where the learning content is associated with one or more of the following representations: HTML, SGML, DHTML, XML, JavaScript, or Flash.

3. The method of claim 2, wherein modifying the user interface comprises disabling at least one of the plurality of interface elements.

4. The method of claim 1, further comprising dynamically changing the learning strategy in accordance with a second command from the learning content.

5. The method of claim 1, where the content is a component of a learning course.

6. The method of claim 1, where the command is one or more statements in a scripting language embedded in the content.

7. The method of claim 1, where the command is a method call exposing a common API for content control.

8. The method of claim 1, where the user interface is configured to navigate to different learning content in accordance with the command from the learning content.

9. The method of claim 1, wherein modifying the user interface comprises automatically navigating between a first component and a second component of the content.

10. A learning system comprising:
memory storing a plurality of learning content; and
one or more processors performing the following operations:
loading content into a content player;
presenting a portion of the content and at least one user interface element on a user interface, the at least one user interface element configured to navigation the content in accordance to a learning strategy; and
modifying the user interface of the content player in accordance with a command from the learning content, where the user interface comprising a plurality of interface elements and at least a subset of the interface elements comprising navigational controls for controlling learning content and modifying includes disabling one or more of the interface elements.

11. The system of claim 10, where the content is associated with one or more of the following representations: HTML, SGML, DHTML, XML, JavaScript, or Flash.

12. The system of claim 10, the one or more processors further performing the operations of:
presenting a second portion of the learning content based on a learner's progress; and
modifying the user interface in accordance with a command from the second portion of the learning content.

13. The system of claim 12, the one or more processors further performing the operation of resetting the user interface prior to presenting the second portion of the learning content.

14. The system of claim 10, the one or more processors further dynamically changing the learning strategy based on metadata associated with the content in accordance with the command from the learning content.

15. The system of claim 10, where the command is one or more statements in a scripting language embedded in the content.

16. The system of claim 10, where the command is a method call exposing a common API for content control.

17. The system of claim 10, where the user interface is configured to navigate to different learning content in accordance with the command from the learning content.

18. The system of claim 10, wherein modifying the user interface further comprises automatically navigating between a first component and a second component of the content.

19. Software comprising instructions stored on a computer readable medium, the software operable when executed to:
load content into a content player, the content associated with a learning strategy; and
modify a user interface of the content player in accordance with a command from the content, where the user interface comprising a plurality of interface elements and at least a subset of the interface elements comprising navigational controls for controlling learning content and modifying includes disabling one or more of the interface elements.

20. The software of claim 19, where the content is associated with one or more of the following representations: HTML, SGML, DHTML, XML, JavaScript, or Flash.

21. The software of claim 19, the software further operable to:
present a second portion of the learning content based on a learner's progress; and
modify the user interface in accordance with a command from the second portion of the learning content.

22. The software of claim 21, the software further operable to reset the user interface prior to presenting the second portion of the learning content.

23. The software of claim 19, the software further operable to dynamically change the learning strategy based on metadata associated with the content in accordance with the command from the learning content.

24. The software of claim 19, where the command is one or more statements in a scripting language embedded in the content.

25. The software of claim 19, where the command is a method call exposing a common API for content control.

26. The software of claim 19, where the user interface is configured to navigate to different learning content in accordance with the command from the learning content.

27. The software of claim 19, wherein modifying the user interface further comprises automatically navigating between a first component and a second component of the content.
